(19) United States
(12) Patent Application Publication
(10) Pub. No.: US 2026/0180813 A1
(43) Pub. Date: Jun. 25, 2026

(54) DOMAIN NAME SYSTEM AUTHORITATIVE SERVER FOR DIGITAL CERTIFICATE REVOCATION CHECK

(71) Applicant: VIRGINIA TECH INTELLECTUAL PROPERTIES, INC., Blacksburg, VA (US)

(72) Inventor: Taejoong Chung, Blacksburg, VA (US)

(21) Appl. No.: 19/424,311

(22) Filed: Dec. 18, 2025

Related U.S. Application Data
(60) Provisional application No. 63/737,044, filed on Dec. 20, 2024.

(51) Int. Cl. H04L 9/32; H04L 9/40

(52) U.S. Cl. CPC H04L 9/3268; H04L 9/3297; H04L 9/40

(57) ABSTRACT

Systems including a domain authoritative nameserver and a certificate authority (CA) authoritative nameserver and methods implemented by the same are described. A method includes maintaining a list of revoked serial numbers corresponding to revoked digital certificates based on revocation by the CA. The revoked digital certificates cannot be used to encrypt data provided to a web server associated with each of the revoked digital certificates. The method also includes obtaining input corresponding to a digital certificate of a web server of interest to a client from a domain name system (DNS) resolver in communication with a client, the input including a serial number, determining if the serial number is among the revoked serial numbers, and providing a response to the DNS resolver regarding a revocation status of the digital certificate.

### CROSS-REFERENCE TO RELATED APPLICATIONS

This application claims priority under 35 U.S.C. § 119(e) to Provisional Ser. No. 63/737,044 , filed Dec. 20, 2024, the entire contents of which are incorporated herein by reference.

### BACKGROUND

When an individual wishes to access a website on the internet, they enter the website name, referred to as a domain name, or a web address, which is a uniform resource locator (URL) that includes the domain and path to a specific page, in an application and/or on their device (e.g., smartphone, computer), which may be referred to as a client. The client's browser may provide the URL to a domain name system (DNS) resolver, which can obtain a corresponding internet protocol (IP) address that allows the client's browser to connect to a server associated with the IP address. The server that hosts the website may be referred to as the web server. Multiple web servers may be associated with a domain.

The communication between a client and many web servers is encrypted. In this case, the client's browser uses a protocol known as transport layer security (TLS), formerly referred to as secure sockets layer (SSL), by using an asymmetric public key infrastructure. A digital certificate (e.g., TLS certificate, SSL certificate) is a digital file that verifies a website's identity and includes the public key that can be used by the client's browser to encrypt data sent to the website (i.e., web server). The web server has a private key that matches the public key and facilitates decryption of the data sent by the client.

An organization referred to as a certificate authority (CA) may issue digital certificates, as well as revoke digital certificates when needed. The CA may be a trusted third party organization that validates the identity of a requester (e.g., person, company, website) of a digital certificate prior to issuing the digital certificate, or the CA may be associated with the website host itself. For a number of reasons (e.g., security risks, unauthorized access, administrative changes), a previously valid digital certificate may be revoked. Revocation refers to invalidation of the digital certificate by the CA prior to its predefined expiration.

### SUMMARY

Certain aspects of the concepts and embodiments described herein are summarized below. The aspects are representative and not exhaustively listed. In alternate embodiments, certain features and elements can be added, omitted, and interchanged with each other. Additionally, variations, extensions, and modifications to the example embodiments can be achieved by those skilled in the art without departing from the concepts, so as to encompass equivalent and related structures.

Various embodiments are disclosed for a CA authoritative nameserver and a domain authoritative nameserver for a digital certificate revocation check. An example computer-implemented method implemented by an authoritative nameserver associated with a certificate authority (CA) for securing web services includes maintaining a list of revoked serial numbers corresponding to revoked digital certificates based on revocation by the CA. The revoked digital certificates cannot be used to encrypt data provided to a web server associated with each of the revoked digital certificates. The method also includes obtaining input corresponding to a digital certificate of a web server of interest to a client from a domain name system (DNS) resolver in communication with the client, the input including a serial number, determining if the serial number is among the revoked serial numbers, and providing a response to the DNS resolver regarding a revocation status of the digital certificate.

In some aspects, maintaining the list of revoked serial numbers includes maintaining an ordered list of hexadecimal representations of the serial numbers. In some aspects, obtaining the input includes obtaining a uniform resource locator of an online certificate status protocol (OCSP) server associated with the CA.

Based on the serial number being among the revoked serial numbers, providing the response to the DNS resolver may include indicating that the digital certificate is revoked. Providing the response to the DNS resolver may also include providing a specified time to live (TTL) duration for validity of the response.

Based on the serial number being absent from the list of the revoked serial numbers, providing the response to the DNS resolver may include indicating that the digital certificate is a non-revoked digital certificate. In some aspects, providing the response to the DNS resolver also includes providing a first revoked serial number among the revoked serial numbers and a second revoked serial number among the revoked serial numbers, the first revoked serial number being a closest preceding number to the serial number among the revoked serial numbers and the second revoked serial number being a closest next number to the serial number among the revoked serial numbers. Providing the response to the DNS resolver may also include providing a specified time to live (TTL) duration for validity of the response.

An example system for providing web services includes an authoritative nameserver associated with a certificate authority (CA). The authoritative nameserver maintains a list of revoked serial numbers corresponding to revoked digital certificates based on revocation by the CA. The revoked digital certificates cannot be used to encrypt data provided to a web server associated with each of the revoked digital certificates. The authoritative nameserver also obtains input corresponding to a digital certificate of a web server of interest to a client from a domain name system (DNS) resolver in communication with the client, the input including a serial number, determines if the serial number is among the revoked serial numbers, and provides a response to the DNS resolver regarding a revocation status of the digital certificate.

In some aspects, the authoritative nameserver maintains the list of revoked serial numbers as an ordered list of hexadecimal representations. In some aspects, the authoritative nameserver obtains a uniform resource locator of an online certificate status protocol (OCSP) server associated with the CA as the input.

In some aspects, based on the serial number being among the revoked serial numbers, the authoritative nameserver provides an indication that the digital certificate is revoked as the response to the DNS resolver. The authoritative nameserver may additionally provide a specified time to live (TTL) duration for validity of the response to the DNS resolver.

In some aspects, based on the serial number being absent from the list of the revoked serial numbers, the authoritative nameserver provides an indication that the digital certificate is a non-revoked digital certificate as the response to the DNS resolver. The authoritative nameserver may additionally provide a first revoked serial number among the revoked serial numbers and a second revoked serial number among the revoked serial numbers, the first revoked serial number being a closest preceding number to the serial number among the revoked serial numbers and the second revoked serial number being a closest next number to the serial number among the revoked serial numbers. In some aspects, the authoritative nameserver also provides a specified time to live (TTL) duration for validity of the response to the DNS resolver.

In some aspects, the system also includes a domain authoritative nameserver to store a mapping, obtain an alias from the DNS resolver and translate the alias to the input based on the mapping, and provide the input to the DNS resolver for forwarding to the authoritative nameserver associated with the CA.

An example computer-implemented method implemented by a domain authoritative nameserver associated with web servers for providing web services includes storing a mapping. The method also includes obtaining an alias from a domain name system (DNS) resolver and translating the alias to an input for a revocation check of a digital certificate based on the mapping; and providing the input to the DNS resolver for forwarding to an authoritative nameserver associated with a certificate authority to implement the revocation check of the digital certificate.

In some aspects, obtaining the alias includes obtaining an alias uniform resource locator (URL) generated by a client in communication with the DNS resolver based on a standard format. Translating the alias to the input may include translating the alias URL to a serial number corresponding to the digital certificate.

### BRIEF DESCRIPTION OF THE DRAWINGS

Many aspects of the present disclosure can be better understood with reference to the following drawings. The components in the drawings are not necessarily to scale, with emphasis instead being placed upon clearly illustrating the principles of the disclosure. Moreover, in the drawings, like reference numerals designate corresponding parts throughout the several views. Repetition of labels for some components may be omitted for clarity of the illustrations.

FIG. 1 is block diagram of aspects of a system for providing web services according to various embodiments.

FIG. 2 is a signal flow diagram illustrating a method of checking for revocation of a digital certificate provided by a web server using the certificate authority (CA) authoritative nameserver according to various embodiments.

FIG. 3 is a signal flow diagram illustrating a method of checking for revocation of a digital certificate using an alias translated by the domain authoritative nameserver according to various embodiments.

FIG. 4 is a block diagram of processing circuitry that may be part of one or more components of the system of FIG. 1.

### DETAILED DESCRIPTION

As noted above, when access to a website is requested by a user at a client, the client's browser obtains the IP address of the web server hosting the website via a DNS resolver. Prior to the use of DNS in this way, a central HOSTS. TXT file was edited and distributed to provide a mapping between hostnames and IP addresses. Unlike the prior approach, DNS is hierarchical and distributed. As previously noted, the client interacts with the DNS resolver, also referred to as a DNS recursive resolver, which may be one of thousands of DNS resolvers accessible publicly, privately, or via an internet service provider (ISP). The client itself may include an additional internal resolver, referred to as a stub resolver, that interacts with the DNS resolver.

The DNS resolver may communicate with multiple DNS servers of the relevant domain to obtain the IP address of the web server needed by the client. Specifically, the DNS resolver may communicate with a DNS root nameserver to obtain information with which to communicate with the appropriate DNS top level domain (TLD) nameserver. The DNS TLD nameserver may provide the IP address of an authoritative DNS nameserver for the domain, referred to herein as the domain authoritative nameserver. The IP address allows the DNS resolver to communicate with the domain authoritative nameserver and obtain the IP address of the web server of interest. The process may include recursive and iterative queries. By maintaining a cache of responses to previous requests for IP addresses, the DNS resolver can decrease latency in the process of retrieving an IP address for a subsequent request from a client.

A DNS resolver may also employ a technique referred to as DNS aggressive negative caching to reduce latency during IP address lookups. This approach involves DNS security extensions (DNSSEC), which is a set of protocols that augment and enhance DNS infrastructure. An aspect of DNSSEC that is relevant to DNS aggressive negative caching is authenticated denial of existence. That is, when a negative response is issued (i.e., some part of the URL was misspelled or, for another reason, does not have a corresponding IP address), a set of next secure (NSEC) records is included in the response from the domain authoritative nameserver as proof of the non-existence of the IP address for the input URL. The NSEC records indicate the valid entries (i.e., valid URLs with corresponding IP addresses) on either side of (i.e., preceding and following) the input invalid URL.

For example, if the URL “calendar.ExDomain.com” is input for a website of interest, the DNS resolver providing “calendar.ExDomain.com” to a domain authoritative nameserver may obtain NSEC records indicating that, not only does the URL “calendar.ExDomain.com” not exist, but also, “blog.ExDomain.com” and “mail.ExDomain.com” are the two existing URLs (with IP addresses) that respectively precede and follow the URL “calendar.ExDomain.com” in the same domain.

The NSEC records are cached by the DNS resolver and are valid for some specified period of time, referred to as time to live (TTL), which may be indicated in seconds. Within that period of time (i.e., TTL), if another URL “date. ExDomain.com” associated with the same domain is provided by a client to the same DNS resolver, the DNS resolver can know that this URL does not exist based on the cached valid range: “blog.ExDomain.com” to “mail.ExDomain.com” (i.e., based on knowing that there are no valid URLs in the alphabetical record between “blog. ExDomain. com” and “mail.ExDomain.com”). Thus, the DNS resolver need not spend time communicating with the domain authoritative nameserver again before providing the response to the client.

As also noted previously, once the correct IP address for the web server is obtained, communication between the client and the web server hosting the website may additionally require a digital certificate. The digital certificate may be obtained by a client's browser via a handshake process (e.g., TLS handshake). That is, the client's browser may initiate the communication with the web server via the IP address obtained from the DNS resolver, and the web server may provide a digital certificate that includes the public key.

Prior to using the public key to encrypt data and communicate with the web server, the browser must ensure that the digital certificate provided by the web server has not been revoked. This certificate validation process or, more accurately, a certificate revocation check process, may be implemented via a security protocol referred to as the online certificate status protocol (OCSP). The CA that issued the digital certificate may have a server, referred to as an OCSP server or OCSP responder, that responds to revocation check requests from browsers. The digital certificate provided by the web server may include the URL of the OCSP responder and a serial number of the digital certificate. A client's browser may send the revocation check request with the serial number of the digital certificate of interest to the OCSP responder of the CA. The OCSP responder may respond to the revocation check request with a simple “Good,” “Revoked,” or “Unknown.”

More particularly, the client may provide the URL of the OCSP server to a DNS resolver to obtain the IP address of the OCSP server. The DNS resolver may communicate with a DNS server of the OCSP server to obtain the IP address of the OCSP server. The client may then access the OCSP server (via HTTP) to check whether the serial number associated with the digital certificate from the web server is revoked.

In this context, an authoritative DNS server of a CA, referred to as a CA authoritative nameserver, that facilitates efficient digital certificate revocation checks is described. The prior approach of using communication between the DNS resolver and the DNS server of the OCSP server to ultimately facilitate communication between the client and the OCSP server is replaced by the CA authoritative nameserver directly providing the digital certificate revocation information to the DNS resolver. According to some embodiments, by implementing DNSSEC, the CA authoritative nameserver facilitates aggressive negative caching of certificate revocation information at the DNS resolver.

Specifically, as further detailed below, a client that received a digital certificate may send the serial number in the digital certificate to a DNS resolver. The DNS resolver may communicate the serial number to the CA authoritative nameserver of a CA associated with the serial number. The CA authoritative nameserver may be identified according to a URL that is also provided in the digital certificate. If the digital certificate is revoked, the CA authoritative nameserver can inform the DNS resolver, which can provide that information to the client and also cache that information to reduce latency for a check of the same digital certificate within a specified period of time (i.e., the TTL provided for the information).

If the digital certificate being checked by the DNS resolver is not revoked, the CA authoritative nameserver implementing DNSSEC may not only indicate that a revocation record is not found for the serial number associated with the digital certificate, but the CA authoritative nameserver may also include a set of NSEC records indicating the serial numbers of revoked digital certificates on either side of (i.e., preceding and following) the serial number of the digital certificate of interest, which is not revoked. This allows the DNS resolver to cache these two serial numbers for a specified period of time (i.e., the TTL), which may be specified by the CA authoritative nameserver. As a result, within that specified period of time, a revocation check for any digital certificate with a serial number between and including those two cached serial numbers could be done more efficiently, without the DNS resolver communicating with the CA authoritative nameserver again.

According to some embodiments, the revocation check may be facilitated by the domain authoritative nameserver and CA authoritative nameserver separately from the digital certificate being received by the client. In this case, the domain authoritative nameserver may facilitate the use of an alias URL, which follows a predefined naming convention, for a revocation check of the digital certificate of interest. That is, the client preparing to access a particular web server may send an alias URL, generated based on the naming convention, to the DNS resolver, which may forward the alias URL to the domain authoritative nameserver of the domain.

The domain authoritative nameserver may translate the alias URL to a serial number and OCSP URL based on a stored mapping. Thus, the client need not wait to receive the digital certificate with the serial number and URL of the associated OCSP server in order to reach the CA authoritative nameserver (via the DNS resolver) and obtain revocation information. Instead, the client may contact the DNS resolver with the alias URL, the DNS resolver may obtain the serial number and URL of the associated OCSP server from the domain authoritative nameserver and forward that information to the CA authoritative nameserver to obtain the result of the revocation check (i.e., confirmation of revocation or the revoked serial numbers immediately preceding and following).

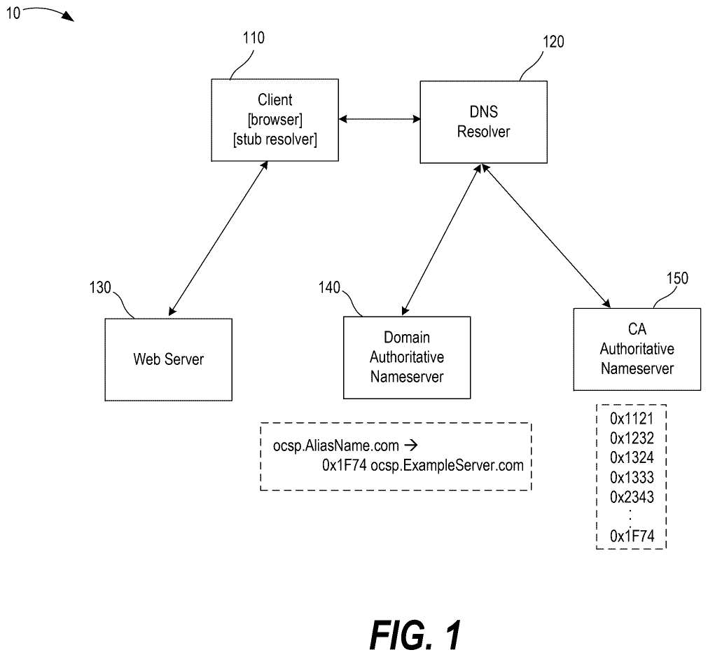

Turning to the drawings, FIG. 1 is block diagram of aspects of a system 10 for providing web services according to various embodiments. A client 110 (e.g., personal computer, smartphone) includes a browser, which is a software application that facilitates interaction with websites on the internet, and may include a stub resolver, which converts application queries into DNS requests and forwards them to a DNS resolver 120. A web server 130 hosts a website that may be of interest to a user at the client 110. A domain authoritative nameserver 140 may be authoritative for a particular set of web servers 130 associated with a domain (including the web server 130 of the website of interest) and may provide an IP address of the web server 130 based on an input URL.

A CA authoritative nameserver 150 may be associated with each CA, according to various embodiments, and may provide responses to OCSP requests. Only records for revoked digital certificates may be stored in the OCSP response zone delegated to the CA authoritative nameserver 150 (i.e., rather than non-revoked or all digital certificates). As previously noted, there may be far fewer revoked digital certificates than valid digital certificates. Thus, storing records for only the revoked digital certificates in the CA authoritative nameserver 150 is more efficient than storing all valid digital certificates.

An exemplary list of serial numbers corresponding to revoked digital certificates is shown in the OCSP response zone of the exemplary CA authoritative nameserver 150. The exemplary list is shown as an ordered list of the hexadecimal serial numbers corresponding to revoked digital certificates. Because the CA authoritative nameserver 150 is affiliated with the CA that issues and revokes digital certificates, the list of serial numbers corresponding to revoked digital certificates that is maintained by the CA authoritative nameserver 150 is the most up-to-date information.

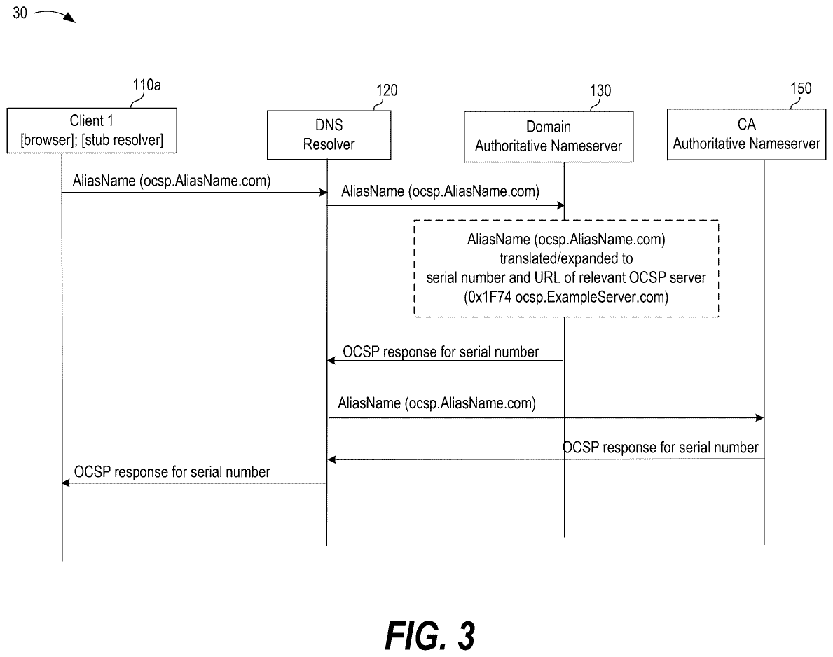

Also shown in FIG. 1 is an exemplary canonical name (CNAME) record, which is a DNS record facilitating the mapping of one domain name, an alias, to another domain name. The domain authoritative nameserver 140 may store the CNAME record to facilitate translating an alias URL to a corresponding serial number and URL of the relevant OCSP server, as further discussed with reference to FIG. 3. The non-limiting examples of information stored by the domain authoritative nameserver 140 and CA authoritative nameserver 150 are only included for explanatory purposes and are not intended to limit the numbers or arrangements of information stored by the domain authoritative nameserver 140 and CA authoritative nameserver 150.

In some aspects, a CA may secure the CA authoritative nameserver 150 designated for OCSP responses with DNSSEC, meaning that the CA authoritative nameserver 150 uses its own signing keys (i.e., zone signing key (ZSK)) and integrity of OCSP responses is ensured without the need for signatures in the OCSP responses. Use of DNSSEC also means that the CA authoritative nameserver 150 may issue NSEC records, which facilitate aggressive negative caching at the DNS resolve 120. As detailed herein, the CA authoritative nameserver 150 may facilitate efficiencies in a digital certificate revocation check. The interaction among the components shown in FIG. 1 are further detailed. One of ordinary skill will understand that other components that are less germane to the embodiments related to a digital certificate revocation check (e.g., DNS root nameserver and DNS TLD nameserver) are not shown or detailed.

As previously mentioned, one aspect of accessing a website from the client 110 involves obtaining the IP address of the web server 130 that hosts the website. The client 110 (e.g., stub resolver of the client 110) may provide the URL of interest to the DNS resolver 120. The DNS resolver 120 may be one of thousands and may be accessible via the ISP being used by the client 110, for example. The DNS resolver 120 may provide the URL of the website of interest to a domain authoritative nameserver 140 and obtain the corresponding IP address of the website. As previously mentioned, the DNS resolver 120 may communicate with the domain authoritative nameserver 140 based on communication with a root nameserver, which facilitates communication with a DNS TLD nameserver, which provides the IP address of the domain authoritative nameserver 140.

According to some embodiments, once the client 110 obtains the IP address of the web server 130 from the DNS resolver 120, the client 110 (e.g., the browser of the client 110) may initiate communication with the web server 130. The web server 130 may provide a digital certificate to the client 110 with a public key to be used to send encrypted transmissions to the web server 130. The digital certificate may include the corresponding serial number and the URL of the OCSP server of the relevant CA.

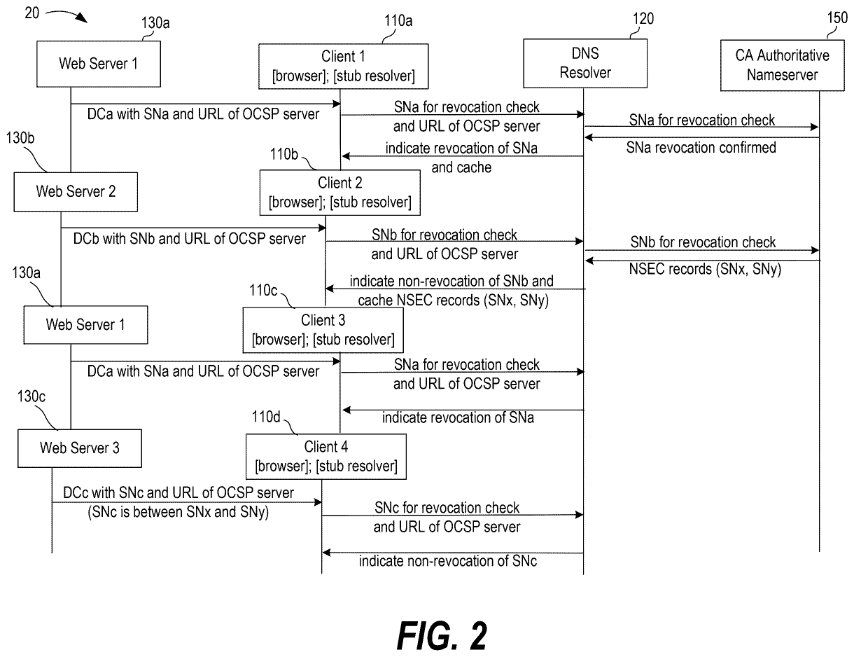

As previously noted, according to a prior approach, the URL of the OCSP server is used to obtain the IP address of the OCSP server and, thereby, to facilitate subsequent communication between the client 110 and the OCSP server. According to various embodiments, a CA authoritative nameserver 150 identifiable via the URL of its associated OCSP server in the digital certificate is used directly for the revocation check. According to various embodiments, the CA authoritative nameserver 150 may facilitate efficient revocation checking for the digital certificate by directly communicating the relevant information to the DNS resolver 120, as further discussed with reference to FIG. 2.

According to some embodiments, the client 110 may initiate a revocation check of the digital certificate with the CA authoritative nameserver 150 prior to obtaining the digital certificate with its serial number and OCSP server URL information from the web server 130. This may be facilitated by a translatable record (i.e., CNAME record) that facilitates the domain authoritative nameserver 140 providing the serial number and OCSP server URL needed by the CA authoritative nameserver 150 based on receiving an alias URL. Aspects of these embodiments are further discussed with reference to FIG. 3.

FIG. 2 is a signal flow diagram illustrating a method 20 of checking for revocation of a digital certificate provided by a web server 130 using the CA authoritative nameserver 150 according to various embodiments. FIG. 2 summarizes aspects of the communication exchanged among the components of the system 10 shown in FIG. 1, including the CA authoritative nameserver 150 according to various embodiments. For explanatory purposes, each of the exemplary clients 110a, 110b, 110c, 110d (which may generally be referred to as client(s) 110) is shown to access the same DNS resolver 120, and the DNS resolver 120 is shown to access the same CA authoritative nameserver 150 in each exemplary interaction. As described below, by employing DNSSEC, the CA authoritative nameserver 150 may provide NSEC records when a serial number is not found among the revoked serial numbers in its OCSP zone. This facilitates negative aggressive caching at the DNS resolver 120 communicating with the CA authoritative nameserver 150.

As shown, a first web server 130a may provide a digital certificate DCa to a client 110a. This communication of the digital certificate DCa, like the communication of other digital certificates (e.g., DCb, DCc) discussed herein, may be preceded by the client 110 obtaining the IP address of the relevant web server 130, as discussed above. The digital certificate DCa may include a corresponding serial number SNa (e.g., 0x1324), represented in hexadecimal format, and the URL of an OCSP server (e.g., ocsp.ExampleServer.com), which is associated with the CA authoritative nameserver 150 shown in FIG. 2.

The client 110a may forward the serial number SNa and URL to the DNS resolver 120 shown in FIG. 2. The DNS resolver 120 may forward the serial number SNa to the CA authoritative nameserver 150, associated with the URL of the OCSP server, and the CA authoritative nameserver 150 may indicate revocation of the serial number SNa. The CA authoritative nameserver 150 may also indicate a specified time period (i.e., TTL) associated with the revocation information. The DNS resolver 120 may indicate the revocation of the digital certificate DCa corresponding to the serial number SNa to the client 110a and may also cache the revoked serial number SNa. The client 110a may provide an error message to the user at the client 110a to indicate that encrypted communication with the requested website is not possible.

A second web server 130b may provide a digital certificate DCb to a second client 110b. The digital certificate DCb may include a corresponding serial number SNb (e.g., 0x2312) and the URL of the relevant OCSP server (e.g., ocsp.ExampleServer.com). As previously noted, the client 110b is assumed to use the same DNS resolver 120 shown in FIG. 2, and the same CA authoritative nameserver 150 is assumed to be associated with the relevant OCSP server. The client 110b communicates with the DNS resolver 120 to provide the serial number SNb for a revocation check and to indicate the URL of the OCSP server. The DNS resolver 120 forwards the serial number SNb to the CA authoritative nameserver 150 and obtains information that the serial number SNb is not revoked.

The information from the CA authoritative nameserver 150, which implements DNSSEC, includes NSEC records indicating the serial numbers SNx (e.g., 0x1333), SNy (e.g., 0x2343) of the revoked serial numbers preceding and following the serial number SNb (e.g., 0x2312), respectively, in the OCSP zone of the CA authoritative nameserver 150. The information from the CA authoritative nameserver 150 may also indicate a specified time period during which the information is valid (i.e., TTL).

Inclusion of the TTL duration may ensure that subsequent revocation of the digital certificate DCb may be determined by the DNS resolver 120 and conveyed to the client 110b. The DNS resolver 120 may indicate the non-revocation of the digital certificate DCb corresponding to the serial number SNb to the client 110b, along with the specified time period (i.e., TTL) after which the DNS resolver 120 must contact the CA authoritative nameserver 150 again for the information for the digital certificate DCb. The DNS resolver 120 may also cache the serial numbers SNx, SNy indicated by the NSEC records. This is an example of aggressive negative caching facilitated by the NSEC records provided by the CA authoritative nameserver 150 and is further discussed below with reference to client 110d. The client 110b may proceed to communicate with the web server 130b using the digital certificate DCb.

As shown in FIG. 2, the first web server 130a may provide the digital certificate DCa to another client 110c. The digital certificate DCa may again include the corresponding serial number SNa and the URL of the relevant OCSP server. Like the client 110a, the client 110c may provide the serial number SNa (e.g., 0x1324) and the URL of the relevant OCSP server (e.g., ocsp.ExampleServer.com) to the DNS resolver 120.

As previously discussed, the DNS resolver 120 caches the indication of revocation for serial number SNa and associated time period for validity of the information (i.e., TTL) based on being provided the serial number SNa by the client 110a. Thus, if the duration between the initial provision of the revocation information for serial number SNa (based on the request from client 110a) and the request from the client 110c is within the TTL, the DNS resolver 120 may be able to provide an indication of revocation of SNa to client 110c without having to communicate with the CA authoritative nameserver 150 again.

As additionally shown in FIG. 2, a web server 130c may provide a digital certificate DCc to a client 110d. The digital certificate DCc may include corresponding serial number SNc (e.g., 0x0143) and the URL of the relevant OCSP server (e.g., ocsp.ExampleServer.com). The exemplary serial number SNc (e.g., 0x0143) is between the values SNx (e.g., 0x1333) and SNy (e.g., 0x2343). The client 110d may forward the serial number SNc and the URL of the relevant OCSP server to the DNS resolver 120.

For explanatory purposes, it is assumed that the DNS resolver 120 obtains the serial number SNc from the client 110d within the specified time period (i.e., TTL) that was previously provided by the CA authoritative nameserver 150 (when it provided the NSEC records based on being forwarded SNb from client 110b). In this case, based on the aggressive negative caching facilitated by the NSEC records (i.e., serial numbers SNx and SNy in the example), the DNS resolver 120 can indicate non-revocation of SNc to the client 110d without having to communicate with the CA authoritative nameserver 150 again.

That is, the serial number SNc (e.g., 0x0143) is between the serial numbers SNx (e.g., 0x1333) and SNy (e.g., 0x2343), which are specified in the NSEC records previously provided by the CA authoritative nameserver 150 and cached by the DNS resolver 120 as a result of checking SNb for revocation. Thus, within the TTL that is also specified by the CA authoritative nameserver 150, the DNS resolver 120 can know that serial number SNc is not among the revoked serial numbers without having to communicate with the CA authoritative nameserver 150 again. In the exemplary case, it should be clear that if, instead, the digital certificate DCc corresponded to serial number SNx or to serial number SNy, the DNS resolver 120 could indicate revocation of the digital certificate DCc without communicating with the CA authoritative nameserver 150 according to the same aggressive negative caching approach.

FIG. 3 is a signal flow diagram illustrating a method 30 of checking for revocation of a digital certificate using an alias URL translated by the domain authoritative nameserver 140 for lookup of a serial number by the CA authoritative nameserver 150 according to various embodiments. The exemplary communication shown in FIG. 3 assumes that the process of obtaining the IP address of a web server 130 of interest has been completed. But, rather than waiting to obtain the digital certificate from the web server 130, the client 110 can use a pre-defined alias URL to check the revocation status of the digital certificate associated with the web server 130. Thus, if the digital certificate is indicated as a non-revoked digital certificate, the client 110 can immediately use the digital certificate upon its receipt from the web server 130.

The client 110 may generate the alias URL based on an established standard. For explanatory purposes, the exemplary domain name is AliasName and the exemplary alias URL is ocsp.AliasName.com. The client 110 sends this alias URL to the DNS resolver 120, which forwards the alias URL to the domain authoritative nameserver 140. As shown in FIG. 3, the domain authoritative nameserver 140 may use a stored CNAME record to translate the alias URL (ocsp.AliasName.com) to a serial number and OCSP server URL (0x1F74 and ocsp.ExampleServer.com).

The domain authoritative nameserver 140 provides the serial number and OCSP server URL to the DNS resolver 120. At this stage, the interaction between the DNS resolver 120 and the CA authoritative nameserver 150 is similar to the communication illustrated in FIG. 2. By obtaining the serial number from the DNS resolver 120, the CA authoritative nameserver 150 can proceed to check the serial number against the list of revoked serial numbers and provide an OCSP response for the serial number. As discussed for the different examples with reference to FIG. 2, the resulting OCSP response provided by the CA authoritative nameserver 150 may indicate that the serial number (e.g., 0x1F74) is not revoked and may include NSEC records and a TTL. Alternately, the OCSP response provided by the CA authoritative nameserver 150 may indicate that the serial number (e.g., 0x1F74) is revoked and include a TTL. The DNS resolver 120 may forward the revocation status of the serial number (e.g., 0x1F74) and also cache this information, as discussed with reference to FIG. 2, to facilitate efficiency in subsequent OCSP responses (within the applicable TTL).

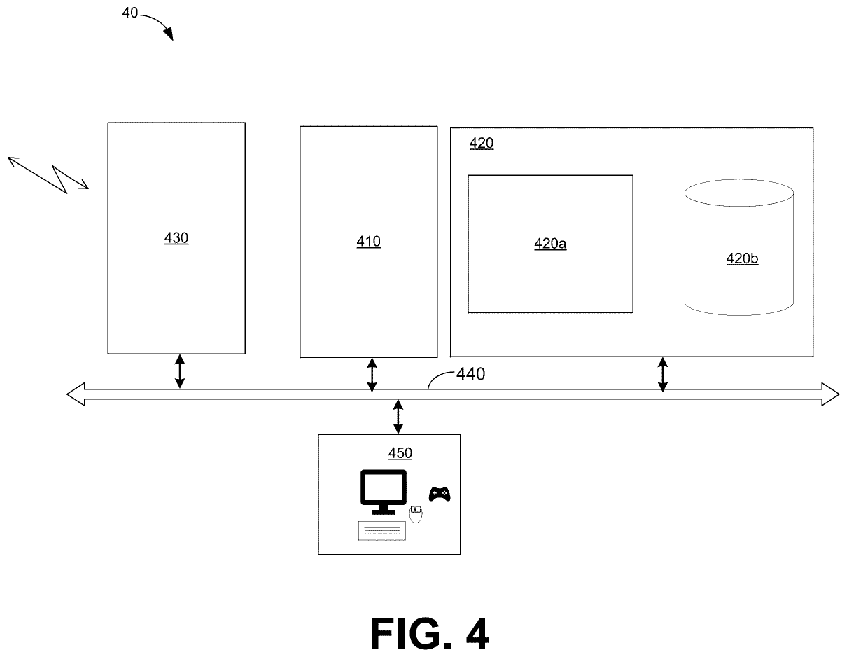

FIG. 4 is a block diagram detailing aspects of components of the system 10 shown in FIG. 1 according to various embodiments. The client 110, DNS resolver 120, web server 130, domain authoritative nameserver 140, and/or CA authoritative nameserver 150 may including processing circuitry 40 shown in FIG. 4 and may be implemented as a server or any other system providing computing capability or may employ a plurality of computing devices arranged, for example, in one or more server banks, computer banks, or other arrangements. The components of the processing circuitry 40 discussed herein and otherwise known to be included are not limited to a specific number of geographic locations or proximity relative to other components. For example, the processing circuitry 40 may include a plurality of computing devices that together may comprise a hosted computing resource, a grid computing resource, and/or any other distributed computing arrangement. In some cases, the processing circuitry 40 may correspond to an elastic computing resource where the allotted capacity of processing, network, storage, or other computing-related resources may vary over time.

The processing circuitry 40 comprises one or more processors 410 and memory 420, including computer-readable media 420a to store instructions that are processed by one or more of the processors 410 and one or more databases 420b to store data. Computer-readable instructions should be understood as including software generated using programming languages such as, for example, C, C++, C #, Objective C, Java®, JavaScript®, Perl, PHP, Visual Basic®, Python®, Ruby, Flash®, or other programming languages. The processing circuitry 40 may also include communication components 430 to facilitate wireless and/or wired communication via the processing circuitry 40. Components of processing circuitry 40 may communicate via any known local interface 440 (e.g., a data bus with an accompanying address/control bus or other bus structure). As previously noted, the components are not limited to being arranged or housed together. Thus, wireless and/or wired communication may be employed among the components of the processing circuitry (e.g., local interface 440 may be implemented as a network).

Any reference to processor 410 should be understood to mean one or more of the processors 410 (implemented sequentially or in parallel), and any reference to processor 410 should be understood to refer to the same, different, or a combination of the same and different processors 410 as other references to processor 410.

One or more processors 410 may comprise technologies that include, but are not limited to, discrete logic circuits having logic gates for implementing various logic functions upon an application of one or more data signals, application specific integrated circuits (ASICs) having appropriate logic gates, field-programmable gate arrays (FPGAs), or other components, etc. Such technologies are generally well known by those skilled in the art and, consequently, are not described in detail herein.

Memory 420 is defined herein as including both volatile and nonvolatile memory and data storage components. Volatile components are those that do not retain data values upon loss of power. Nonvolatile components are those that retain data upon a loss of power. Thus, the memory 420 may comprise, for example, random access memory (RAM), read-only memory (ROM), hard disk drives, solid-state drives, USB flash drives, memory cards accessed via a memory card reader, floppy disks accessed via an associated floppy disk drive, optical discs accessed via an optical disc drive, magnetic tapes accessed via an appropriate tape drive, and/or other memory components, or a combination of any two or more of these memory components. In addition, the RAM may comprise, for example, static random access memory (SRAM), dynamic random access memory (DRAM), or magnetic random access memory (MRAM) and other such devices. The ROM may comprise, for example, a programmable read-only memory (PROM), an erasable programmable read-only memory (EPROM), an electrically erasable programmable read-only memory (EEPROM), or other like memory device. In the context of the present disclosure, a computer-readable medium is memory 420 that can be any medium that can contain, store, or maintain the logic or application described herein for use by or in connection with the processing circuitry 40.

For example, processing circuitry 40 of the CA authoritative nameserver 150 may include a computer-readable medium as part of its memory 420. The computer-readable medium may store instructions that, when processed by one or more processors 410, implement the methods discussed with reference to FIGS. 2 and 3. The memory 420 may additionally store the serial numbers of revoked digital certificates.

As another example, processing circuitry 40 of the domain authoritative nameserver 140 may include a computer-readable medium as part of its memory 420, and the computer-readable medium may store instructions that, when processed by one or more processors 410, implements aspects of the method discussed with reference to FIG. 3. The memory 420 may additionally store the CNAME record, which is the mapping that facilitates translating an alias URL to a corresponding serial number of a digital certificate and OCSP server URL.

The processing circuitry 40 associated with one or more of the components may additionally include user interface components 450 including one or more displays and input devices. The user interface components 450 may include, for example, one or more display devices such as liquid crystal display (LCD) displays, gas plasma-based flat panel displays, organic light emitting diode (OLED) displays, electrophoretic ink (E ink) displays, LCD projectors, or other types of display devices, etc. Input devices may include a keyboard, mouse, handheld console, etc.

The features, structures, or characteristics described above may be combined in one or more embodiments in any suitable manner, and the features discussed in the various embodiments are interchangeable, if possible. In the description, numerous specific details are provided in order to fully understand the embodiments of the present disclosure. However, a person skilled in the art will appreciate that the technical solution of the present disclosure may be practiced without one or more of the specific details, or other methods, components, materials, and the like may be employed without deviating from the scope of the disclosure or the spirit of the claims. In other instances, well-known structures, materials, or operations are not shown or described in detail to avoid obscuring aspects of the present disclosure.

Terms such as “approximately,” “substantially,” or “about” may be used to account for minor variations in values, relative positions (e.g., substantially parallel or perpendicular), or other descriptors. The amount of variation may be defined by tolerances (e.g., manufacturing tolerances) or conventions understood by those of ordinary skill in the art pertinent to the disclosure. When relative terms such as “on,” “below,” “upper,” “lower,” “front,” “back,” and “rear” are used in the specification to describe the relative relationship of one component to another component, these terms are used in this specification for convenience only, for example, as a direction in relation to an orientation shown in the drawings. When a structure is “on” another structure, it is possible that the structure is integrally formed on another structure, or that the structure is “directly” disposed on another structure, or that the structure is “indirectly” disposed on the other structure through other structures.

In this specification, the terms such as “a,” “an,” “the,” and “said” are used to indicate the presence of one or more elements and components. The terms “comprise,” “include,” “have,” “contain,” and their variants are used to be open ended, and are meant to include additional elements, components, etc., in addition to the listed elements, components, etc. unless otherwise specified in the appended claims.

The terms “first,” “second,” etc. are used only as labels, rather than a limitation for a number of the objects. It is understood that if multiple components are shown, the components may be referred to as a “first” component, a “second” component, and so forth, to the extent applicable.

Disjunctive language such as the phrase “at least one of X, Y, or Z,” unless specifically stated otherwise, is understood as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, and at least one of Z to each be present.

The above-described embodiments of the present disclosure are merely possible examples of implementations set forth for a clear understanding of the principles of the disclosure. Many variations and modifications may be made to the above-described embodiment(s) without departing substantially from the principles of the disclosure. All such modifications and variations are intended to be included herein within the scope of this disclosure and protected by the following claims.

Therefore, the following is claimed:

1. A computer-implemented method implemented by an authoritative nameserver associated with a certificate authority (CA) for securing web services, the method a comprising:
maintaining a list of revoked serial numbers corresponding to revoked digital certificates based on revocation by the CA, wherein the revoked digital certificates cannot be used to encrypt data provided to a web server associated with each of the revoked digital certificates;
obtaining input corresponding to a digital certificate of a web server of interest to a client, from a domain name system (DNS) resolver in communication with the client, the input including a serial number;
determining if the serial number is among the revoked serial numbers; and
providing a response to the DNS resolver regarding a revocation status of the digital certificate.

2. The method according to claim 1, wherein maintaining the list of revoked serial numbers includes maintaining an ordered list of hexadecimal representations of the serial numbers.

3. The method according to claim 1, wherein obtaining the input includes obtaining a uniform resource locator of an online certificate status protocol (OCSP) server associated with the CA.

4. The method according to claim 1, wherein, based on the serial number being among the revoked serial numbers, providing the response to the DNS resolver includes indicating that the digital certificate is revoked.

5. The method according to claim 4, wherein providing the response to the DNS resolver also includes providing a specified time to live (TTL) duration for validity of the response.

6. The method according to claim 1, wherein, based on the serial number being absent from the list of the revoked serial numbers, providing the response to the DNS resolver includes indicating that the digital certificate is a non-revoked digital certificate.

7. The method according to claim 6, wherein providing the response to the DNS resolver also includes providing a first revoked serial number among the revoked serial numbers and a second revoked serial number among the revoked serial numbers, the first revoked serial number being a closest preceding number to the serial number among the revoked serial numbers and the second revoked serial number being a closest next number to the serial number among the revoked serial numbers.

8. The method according to claim 6, wherein providing the response to the DNS resolver also includes providing a specified time to live (TTL) duration for validity of the response.

9. A system for providing web services, the system comprising:
an authoritative nameserver associated with a certificate authority (CA), the authoritative nameserver configured to:
maintain a list of revoked serial numbers corresponding to revoked digital certificates based on revocation by the CA, wherein the revoked digital certificates cannot be used to encrypt data provided to a web server associated with each of the revoked digital certificates;
obtain input corresponding to a digital certificate of a web server of interest to a client from a domain name system (DNS) resolver in communication with the client, the input including a serial number;
determine if the serial number is among the revoked serial numbers; and
provide a response to the DNS resolver regarding a revocation status of the digital certificate.

10. The system according to claim 9, wherein the authoritative nameserver is configured to maintain the list of revoked serial numbers as an ordered list of hexadecimal representations.

11. The system according to claim 9, wherein the authoritative nameserver is configured to obtain a uniform resource locator of an online certificate status protocol (OCSP) server associated with the CA as the input.

12. The system according to claim 9, wherein, based on the serial number being among the revoked serial numbers, the authoritative nameserver is configured to provide an indication that the digital certificate is revoked as the response to the DNS resolver.

13. The system according to claim 12, wherein the authoritative nameserver is configured to additionally provide a specified time to live (TTL) duration for validity of the response to the DNS resolver.

14. The system according to claim 9, wherein, based on the serial number being absent from the list of the revoked serial numbers, the authoritative nameserver is configured to provide an indication that the digital certificate is a non-revoked digital certificate as the response to the DNS resolver.

15. The system according to claim 14, wherein the authoritative nameserver is further configured to provide a first revoked serial number among the revoked serial numbers and a second revoked serial number among the revoked serial numbers, the first revoked serial number being a closest preceding number to the serial number among the revoked serial numbers and the second revoked serial number being a closest next number to the serial number among the revoked serial numbers.

16. The system according to claim 14, wherein the authoritative nameserver is further configured to provide a specified time to live (TTL) duration for validity of the response to the DNS resolver.

17. The system according to claim 9, further comprising a domain authoritative nameserver configured to:
store a mapping;
obtain an alias from the DNS resolver and translate the alias to the input based on the mapping; and
provide the input to the DNS resolver for forwarding to the authoritative nameserver associated with the CA.

18. A computer-implemented method implemented by a domain authoritative nameserver associated with web servers for providing web services, the method comprising:
storing a mapping;
obtaining an alias from a domain name system (DNS) resolver and translating the alias to an input for a revocation check of a digital certificate based on the mapping; and
providing the input to the DNS resolver for forwarding to an authoritative nameserver associated with a certificate authority to implement the revocation check of the digital certificate.

19. The method according to claim 18, wherein obtaining the alias includes obtaining an alias uniform resource locator (URL) generated by a client in communication with the DNS resolver based on a standard format.

20. The method according to claim 19, wherein translating the alias to the input includes translating the alias URL to a serial number corresponding to the digital certificate.
